(19) United States
(12) Patent Application Publication
(10) Pub. No.: US 2016/0344701 A1
(43) Pub. Date: Nov. 24, 2016

(54) SYSTEMS AND METHODS FOR A TWO-WAY COMMON POOL PROXY TO OBSCURE COMMUNICATION ROUTING

(71) Applicant: Shadow SMS, LLC, Leawood, KS (US)

(72) Inventor: Aaron Martens, Cave Creek, AZ (US)

(73) Assignee: SHADOW SMS, LLC, Leawood, KS (US)

(21) Appl. No.: 14/658,228

(22) Filed: Mar. 15, 2015

Related U.S. Application Data
(60) Provisional application No. 62/119,374, filed on Feb. 23, 2015.

(51) Int. Cl. H04L 29/06

(52) U.S. Cl. CPC H04L 63/0421

(57) ABSTRACT

Method and system is disclosed for obscuring a message origin. The method includes provisioning a first alias address of the finite plurality of alias addresses for a recipient device having a first real address, transmitting a message to the originating device from the first alias address, receiving a message from the originating device addressed to the first alias address, identifying a real address associated with the first alias address within the database based upon an originating device's address and the first alias address, associating a second alias address of the finite plurality of alias addresses with the originating device having the second real address within the database, associating the received message from the originating device with the first real address and the second alias within the database, and transmitting the received message to the recipient device associated with the first real address using the second alias as an originating address.

### CROSS REFERENCE TO RELATED APPLICATIONS

This application claims the benefit of U.S. Provisional Application No. 62/119,374 filed on Feb. 23, 2015 which is hereby incorporated herein by reference.

### TECHNICAL FIELD

This disclosure relates generally to anonymous wireless communication and more specifically to systems and methods of anonymous communication between two mobile device users.

### BACKGROUND

The statements in this section merely provide background information related to the present disclosure and may not constitute prior art.

Short message service (SMS) based communication services enable sharing of text-only messages between mobile devices. A typical protocol for sending SMS messages limits text to 160 characters per message. Multimedia messaging service (MMS) based messaging services extend SMS capability by enabling inclusion of multimedia content, e.g., graphical images, in messages sent between mobile devices.

In the past, the SMS technology has not been very good at providing anonymity to users. There is little or no provision to protect the identity of a user using the default text-messaging application that is shipped or installed as default with the mobile phone handset. There is no seamless method of protecting a user's caller identification in SMS messages sent from the default SMS application. Hence, there is a need for processes that provide for two-way anonymous messaging, e.g., communications between the originating party and a second, recipient party, whereby the first and second party's identify is obscured among network elements and the first and second user's mobile devices.

### SUMMARY

Method and system is disclosed for obscuring a message origin. The method includes provisioning a first alias address of the finite plurality of alias addresses for a recipient device having a first real address, transmitting a message to the originating device from the first alias address, receiving a message from the originating device addressed to the first alias address, identifying a real address associated with the first alias address within the database based upon an originating device's address and the first alias address, associating a second alias address of the finite plurality of alias addresses with the originating device having the second real address within the database, associating the received message from the originating device with the first real address and the second alias within the database, and transmitting the received message to the recipient device associated with the first real address using the second alias as an originating address.

Certain embodiments of the invention include a feature of communicating anonymously using SMS-type messages and/or MMS-type messages.

Certain embodiments of the invention include a feature of supplying a predetermined ASCII character sequence before the first real address to execute the request for provisioning a recipient device.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a high-level overview schematic diagram illustrating an exemplary system for anonymous communication, in accordance with the present disclosure;

FIG. 2 shows an exemplary computing device, in accordance with the present disclosure;

FIG. 3 is a sequence diagram depicting an exemplary provisioning sequence for anonymous communication flow between a first user and a second user, in accordance with the present disclosure;

FIG. 4 illustrates an exemplary sequence diagram depicting anonymous communication flow between a first user and a second user, in accordance with the present disclosure;

FIG. 5 shows an exemplary table illustrating data variables used by the application server during operation, in accordance with the present disclosure; and

FIG. 6 shows an exemplary flow of communications among the mobile devices and the application server, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

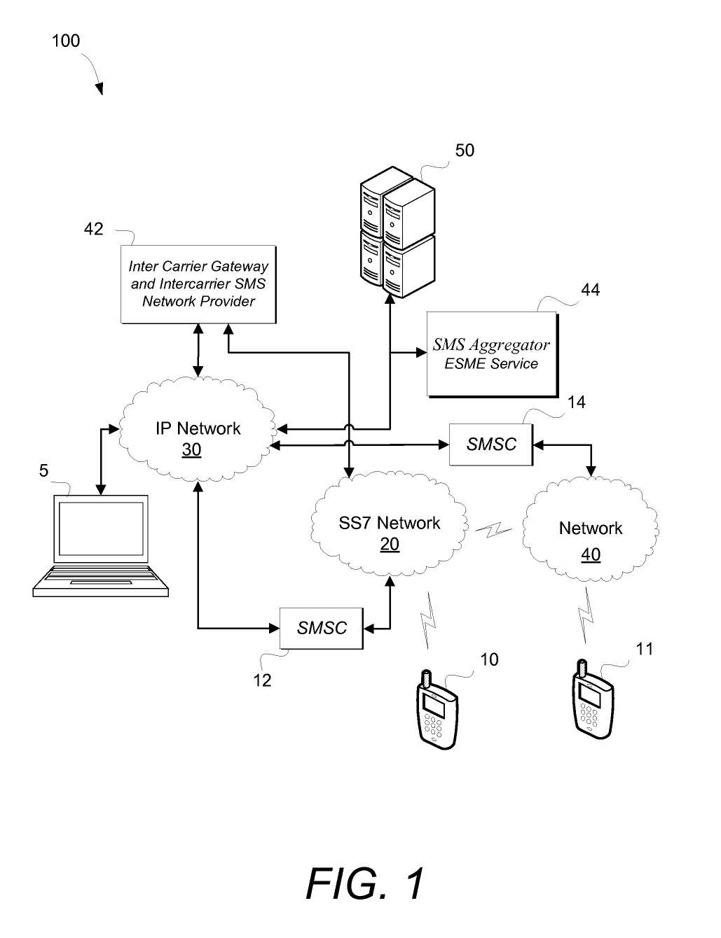

FIG. 1 includes various operationally and communicatively interconnected networks of various topologies, including a wireless SS7 network 20 in which various communications based upon a Mobile Application Part (MAP) based protocols, e.g., GSM MAP and IS41 MAP, for example, may be exchanged with various interconnected network elements to provide mobile telecommunications. An exemplary wireless network 20 is a signaling system 7 (SS7) network in which MAP short message service (SMS) and other MAP messages are exchanged, transferred, or otherwise processed or utilized. With respect to the present disclosure, the network 20 allows exchange of SMS messages to and from wireless mobile devices 10, wherein the various systems and methods of the invention are applicable to anonymize various communications between mobile devices 10 and 11 and/or computing devices 5.

In various embodiments, additional network elements may be included among or within the networks 20, 30, and 40 such as a short message service center (SMSC) 12, a single mobile switching center (MSC) and an associated home location register (HLR), although it will be appreciated that the system 100 may include any number of MSCs, HLRs, visitor location registers (VLR), as well as base station systems, base station controllers, etc., and other network elements (not shown) for implementing the teachings herein.

The network 20 may be communicatively connected with an Internet Protocol (IP) network 30 or other packet-based network for providing communications with one or more IP-based devices, such as a computing device 5, wherein the IP-based system 30 is communicatively connected to one or more network servers for coupling the packet-switched IP network 30 with the network 20. In various embodiments, the network servers are configured to provide inter carrier gateway routing and SMPP short messaging (SMS) services between IP-based devices computing devices 5 and the exemplary mobile device 10 and other devices associated with the network 20, e.g., the application server 50. In various embodiments, the SMPP SMS services can be resident on one network element or can be distributed across multiple network elements within the networks 20 and 30. In various embodiments, the one or more network servers 40 are communicatively connected to one or more SMS aggregation and ESME services 42.

In various embodiments, the network 40 may include any suitable series of points or nodes interconnected by communication paths. The network 40 may be interconnected with other networks and contain sub networks network such as, for example, a publicly accessible distributed network like the Internet. In one embodiment, the network 40 includes an IP-based network similar to network 30. Elements of the network 40 may provide inter carrier gateway routing and SMPP SMS services among IP-based devices such as the computing devices 5, the mobile device 10 and the mobile device 11. In various embodiments, the network 20 may be communicatively coupled to one or more additional networks 40 for message exchange between a mobile device 10 connected to the first network 20 and a mobile communications device 11 communicatively connected to the second network 40. The network 40 may be communicatively connected to a short message service center 14 to allow devices such as the mobile device 11 to send SMPP SMS messages via the IP network 30 or similar.

The IP network 30 may operate to transfer SMPP SMS messages from External Short Messaging Entity (ESME) sources such as the computing device 5 or other ESME communicatively connected with the IP network 30 to communications devices associated with the wireless network 20 via the SMSC 12, and also allows devices such as the mobile device 10 to send SMPP SMS messages to the ESME 5 via the SMSC 12 and the IP network 30. In this way, networks 20 and 30 can provide communicative connection of various communications devices and network elements for various communications and anonymous communications, as described herein below, including, e.g., inter carrier gateway routing to one or more foreign networks. In various embodiments, the IP network 30 may operate to transfer MMS messages from one or more mobile devices, e.g., devices 10 and 11, through the SMSC 12 and/or SMSC 14.

SMS and MMS messages may be directed through networks 20, 30, and/or 40 using real addresses associated with a particular device. In one embodiment the read address is a North American Numbering Plan Administration (NANPA) telephone number. NANPA telephone numbers may be ten-digit numbers consisting of a three-digit Numbering Plan Area (NPA) code (or area code), followed by a seven-digit number. In one embodiment, the real address is a Session Initiation Protocol (SIP) address. The SIP address may include a Uniform Resource Identifier. In one embodiment, the real address is an E.164-type address. In various embodiments, the real address may be formatted according to a particular network protocol utilized by connected and registered devices such as VoLTE, VoWifi, RCS, and WebRTC type messaging networks.

An application server 50 is preferably communicatively connected through the IP network 30 via various SMPP or web services based communications tools, e.g., API. The application server 50 can be any suitable combination of hardware, software, logic, etc., whether unitary or distributed, whereby the various anonymizing aspects of the disclosure can be easily scaled according to network traffic conditions on a dynamic basis. The application server 50 in the illustrated embodiment can be accessed for programming via a computing device 5 communicatively connected with the network 30 for adaptation, programming, updating, etc. by a user and/or a service provider for configuring one or more parameters associated with the anonymizing features described herein.

The application server 50 may be various embodiments of a computer including high-speed microcomputers, minicomputers, mainframes, and/or data storage devices. The application server 50 may be configured to execute database functions including storing and maintaining a database and processes requests from the mobile devices 10 and 11 and the computing device 5 to extract data from, or update, a database. The application server 50 may additionally provide processing functions for the mobile devices 10 and 11 and the computing device 5 as will become apparent to those skilled in the art upon a careful reading of the teachings herein.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

The computing device 5 and the application server 50 may be various embodiments of a computer including high-speed microcomputers, minicomputers, mainframes, and/or data storage devices without departing from the teachings herein.

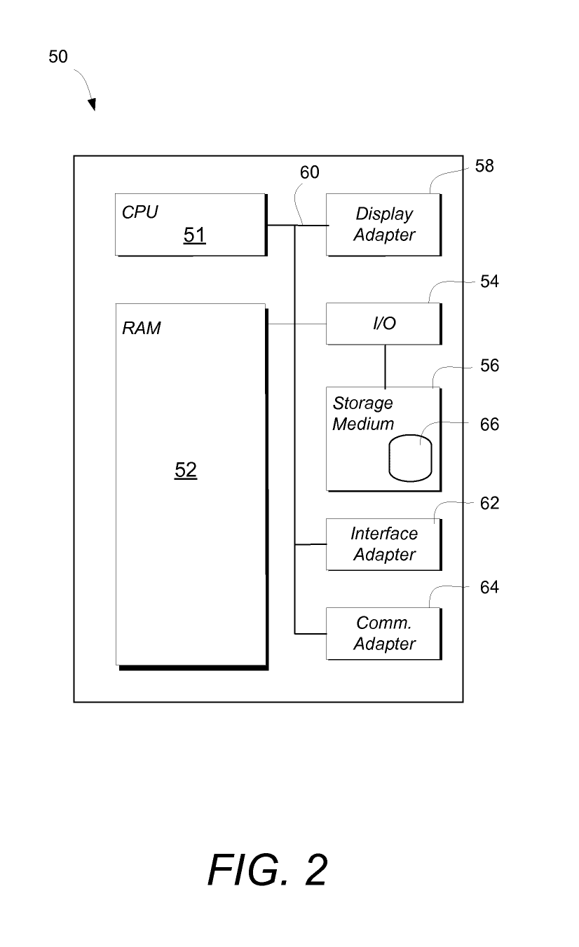

FIG. 2 shows the exemplary computing device and may be used in various embodiments of the application server 50. The computing device includes a central processing unit (CPU) 51, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the computing device to the network 20. In one embodiment, the communication adapter 64 is a wireless adapter configured for extraterrestrial communication such as in a communications satellite. The storage medium 56 is configured to store, access, and modify a database 66, and is preferably configured to store, access, and modify structured or unstructured databases for data including, for example, relational data, tabular data, audio/video data, and graphical data.

The central processing unit 51 is preferably one or more general-purpose microprocessor or central processing unit(s) and has a set of control algorithms, comprising resident program instructions and calibrations stored in the memory 52 and executed to provide the desired functions including parallel processing functions. As one skilled in the art will recognize, the central processing unit 51 may have any number of processing “cores” or electronic architecture configured to execute processes in parallel. In one embodiment, an application program interface (API) is preferably executed by the operating system for computer applications to make requests of the operating system or other computer applications. The description of the central processing unit 51 is meant to be illustrative, and not restrictive to the disclosure, and those skilled in the art will appreciate that the disclosure may also be implemented on platforms and operating systems other than those mentioned.

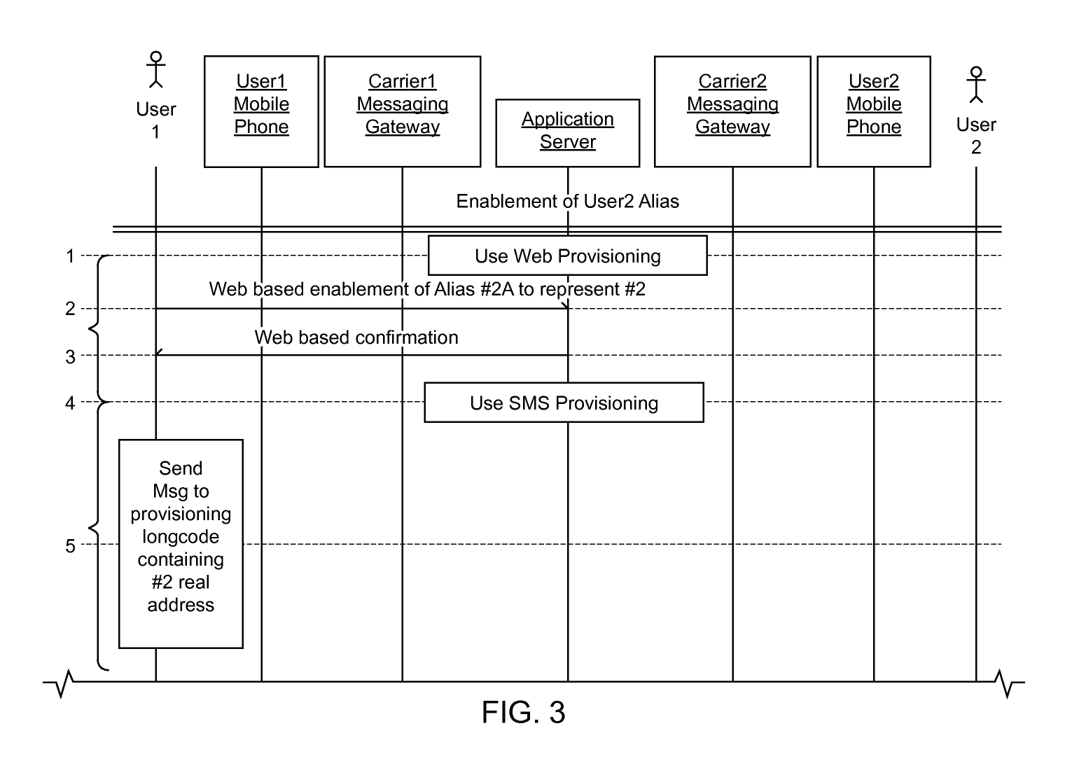

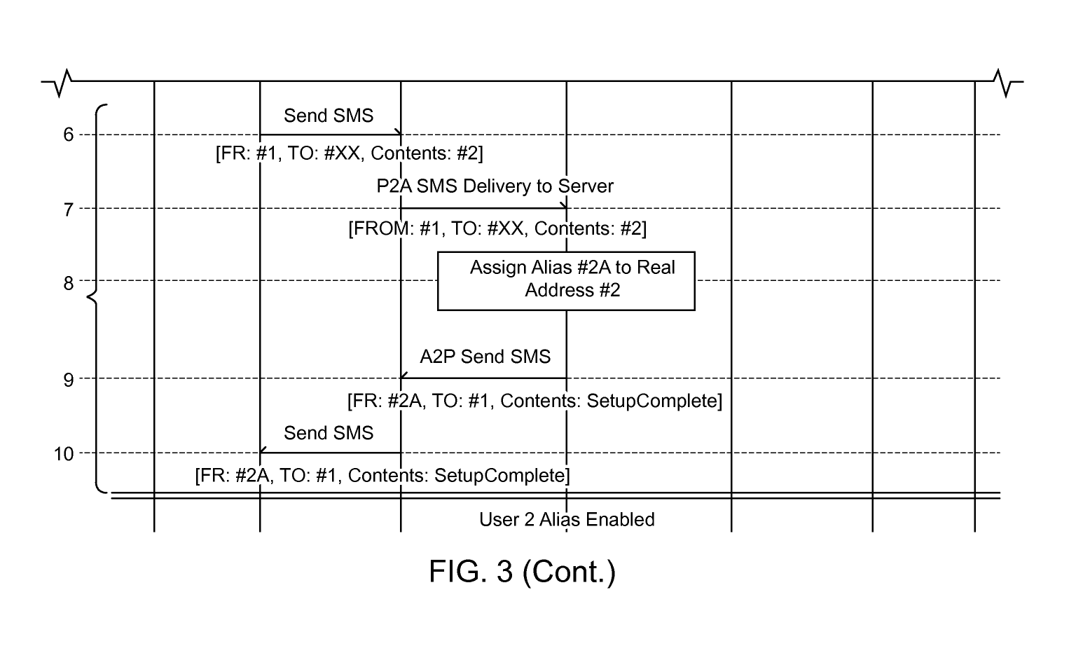

FIG. 3 illustrates an exemplary sequence diagram depicting an exemplary provisioning sequence for anonymous communication flow between a first user 1 and a second user 2, whereby the first user 1 is anonymous to the second user 2 and the second user 2 is anonymous to the first user 1. Provisioning may be executed via a web-based interference or a SMS-based process. In various embodiments, provisioning minimally requires contact information for a user such as a phone number. In various additional embodiments provisioning requires additional contact information such as a name associated with a user.

Provisioning via web-based interface is initialized by the user 1 by sending registration or contact information for a user 2 to the server 50. User 2 is then assigned a long code, e.g., longcode2, which is stored in conjunction with user 2's registration information and transmitted to user 1 along with successful confirmation, in one embodiment. In various embodiments, the longcode is a phone number.

Provisioning via SMS communication is initiated by user 1. In various embodiments, the user 1 may initiate the provisioning process by sending a message to a specially pre-assigned address or 10 digit longcode, in one embodiment, whereby the message includes a real address associated with user 2, e.g., user 2's phone number. In some embodiments, the pre-assigned address or longcode is a 10 digit phone number associated with the application server 50. In one embodiment, the user 1 may simply enable the provisioning and anonymous communication to the application server 50 by sending a predetermined ASCII character sequence, e.g., @@ followed by the intended recipient's real address, e.g., “@@ xxx-xxx-xxxx.” In this way, the request for anonymous communication is sent to the application server 50 automatically, without requiring explicit addressing by the user 1, enabling the system to utilize native application processes. As used herein, “native” or “natively” is defined as operations supported within the system software of the mobile device.

In one embodiment, the message may be sent along with an intended text block message, in the body of the message, with a specified delimiter (e.g., a space) between the user 2's real address and a beginning of the text block. In one embodiment, the user 1 may send the intended text block message after receiving confirmation of successful provisioning. SMS messages sent to a long code are forwarded to the server 50 switch by the sender's mobile service provider, e.g., network 20 operator, which then posts the message details to the messaging gateway, e.g., SMSC 12.

In various embodiments, this provisioning request is executed by user 1 for the alias of user 2 through a communication from the user's mobile device 10 sent to a carrier gateway center which may be the SMSC 12, and then on to the application server 50. Upon initiating the communication, a provisioning sequence is executed, generating an alias for user 1 to identify user 2, i.e., an alias associated with user 2 or user 2's mobile device 11. In one embodiment, the application server 50 may then send confirmation of a successful alias generation to the user 1. In various embodiments, the alias is a longcode representing contact information, e.g., phone number. In various embodiments, the confirmation message is sent by the application server 50 as originating from the generated alias. In this way, from user 1's perspective, s/he has received an initial message from the alias from which s/he may directly reply.

In various embodiments, the application server 50 receives the originating message from user 1 that includes the real address of user 2. The application server 50 parses the message of the real address associated with user 2 and generates a dynamic alias for association to the real address of user 2. The application server 50 may then send confirmation of successful alias generation to the user 1, e.g., “setup complete”, through the gateway center 12 and mobile device 10 in the form of a SMS communication. In one embodiment, the application server 50 sends a message to the user 1 from the dynamic alias associated with user 2 in response to the successful alias generation so that the user 1 may simply respond to the message in native. In various mobile device embodiments, the receipt of a message initiates a native conversation module. By sending a message to the user 1 in response to the successful alias generation, responses to that message by user 1 are sent to user 2 anonymously without requiring additional input from user 1.

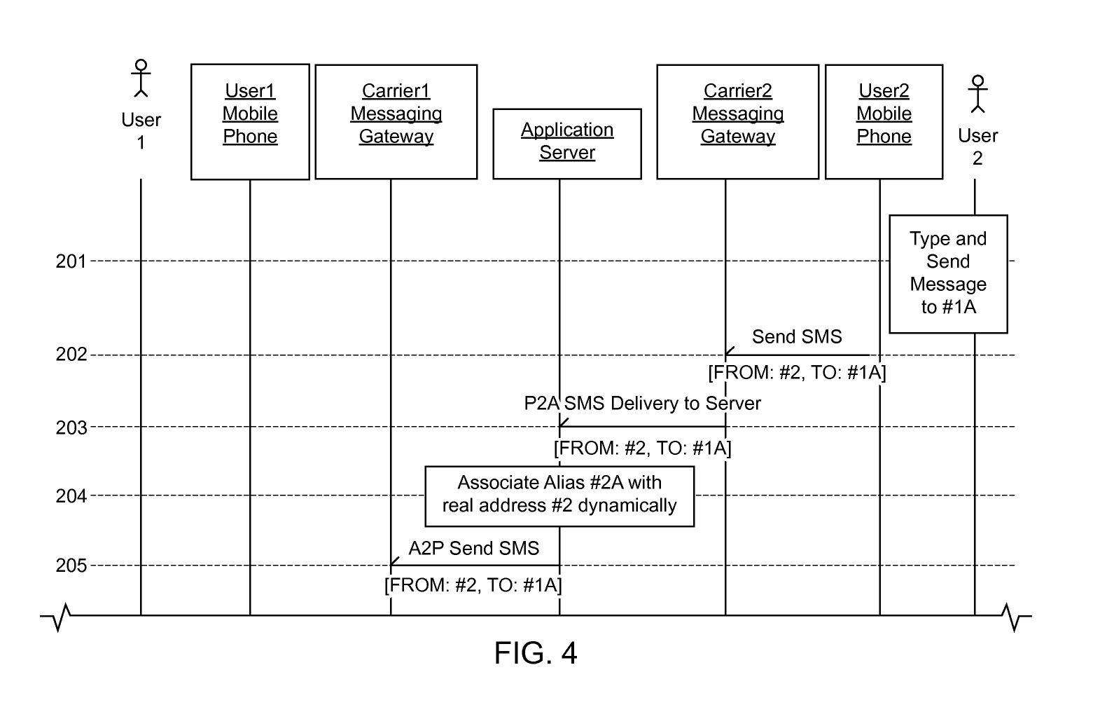

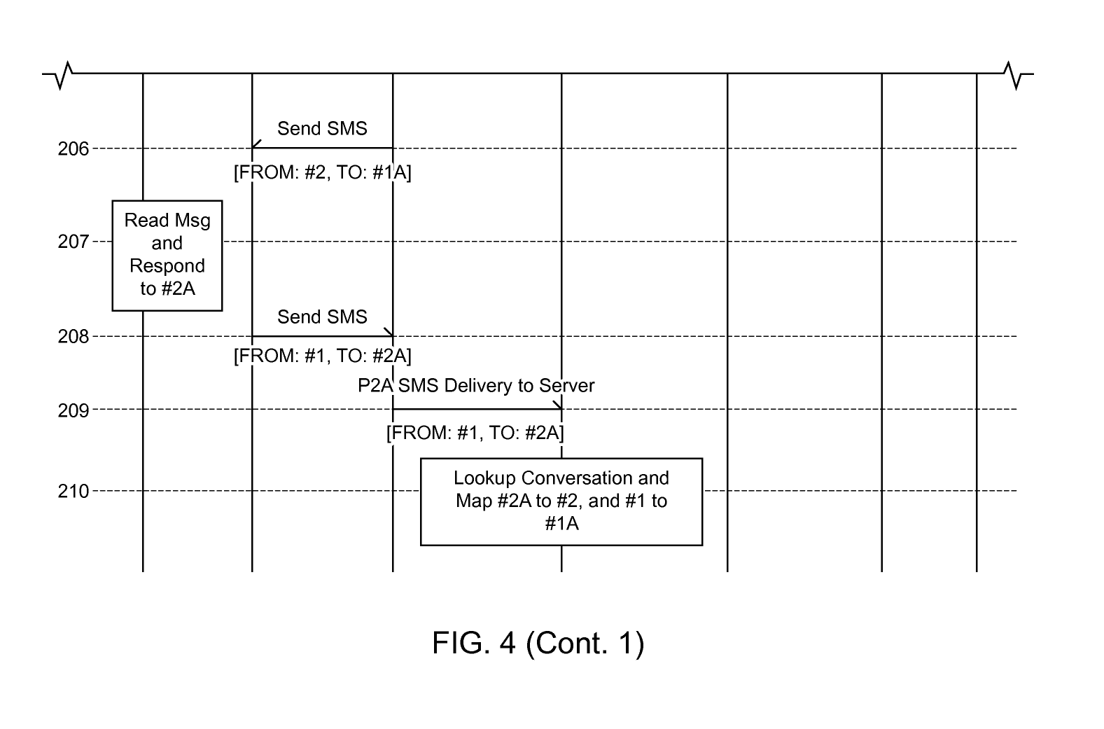

FIG. 4 illustrates an exemplary sequence diagram depicting anonymous communication flow between a first user 1 and a second user 2, whereby the first user 1 is anonymous to the second user 2 and the second user 2 is anonymous to the first user 1. In the exemplary communication sequence, provisioning and enablement of alias addresses for user 1 and user 2 have be executed and stored within the application server 50. Enablement of alias addressing and provisioning may be initiated by either of the users 1 and 2 or an administrator of the server 50.

In one exemplary communication operation, user 2 initiates a message addressed to 1A at step 201. In this exemplary operation, user 1 is anonymous to user 2, i.e., user 2 does not know where or to whom the message will be terminally delivered. At exemplary step 202, the message is sent via SMS protocol to 1A through mobile device 11 to any number of network components that may include gateway center 14. At step 203, the SMS message is delivered to the application server 50. At step 204, upon receipt of the message from user 2 to address 1A, the application server 50: (1) associates the message with a generated alias address corresponding to user 2, e.g., 2A; and (2) identifies a real address associated with address 1A. By using user 2's contact information, user 2's alias 2A, and address 1A, the application server 50 can determine that the correct forwarding address is user 1's.

At step 205, the application server 50 then transmits the message as originating from 2A to the real address of user 1. The message may be sent via SMS protocol to any number of network components that may include gateway center 12 for delivery to the mobile device 10 associated with user 1 at step 206. At exemplary step 207 the user 1 may read the message upon receipt of the message. At step 208, the user 1 may respond by addressing a SMS message to address 2A. At step 209, the SMS message is received by one or more network components for transmission and relay to the application server 50.

At step 210, similar to above, the message to 2A is received by the application server 50 from user 1 and subsequently anonymized by (1) associating the message as originating from address 1A; and (2) directing the message to the real address associated with address 2A, e.g., the address associated with mobile device 11 and user 2. At step 211, the message may then be sent from the application server 50 via SMS protocol to any number of network components that may include gateway center 14. At step 212 one or more network components may forward, relay, or transmit the SMS message to the mobile device 11. At step 213, the user 2 may read the received message on the mobile device 11. In this way, both real identities of user 1 and 2 are unknown to respective parties of user 1 and user 2, and any 3^{rd} party associated with network components such as gateway centers 12 and 14 that may intercept for message forwarding along successful messaging transmission.

In other embodiments, users may send encrypted anonymous SMS messages. To send an encrypted message, the sender uses a long code reserved just for anonymous encrypted messages. In this scenario, once sent, the message body is encrypted by the application server 50 using an encryption algorithm. In one embodiment, instead of sending the actual message, a link to the encrypted message stored in memory is sent to the recipient. To open the message, the recipient must then use a key or phrase pre-determined by sender and receiver and encryption mechanism.

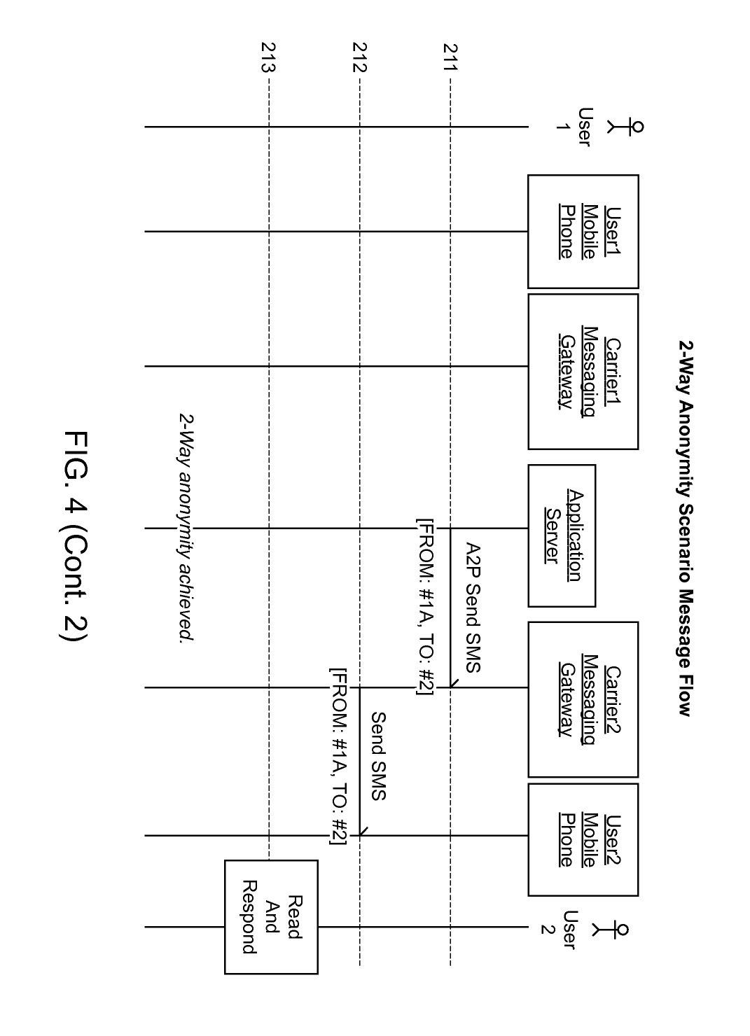

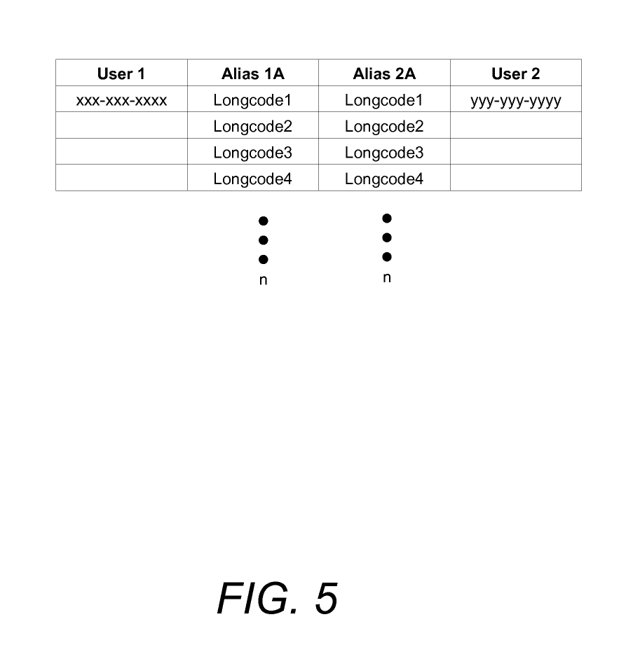

FIG. 5 shows an exemplary table illustrating data variables used by the application server 50 during operation. As FIG. 5 shows, user 1 is associated with an address (xxx-xxx-xxxx), user 2 is associated with an address (yyy-yyy-yyyy), alias 1A and 2A can be a longcode. In one embodiment, alias 1A and 2A are different. In one embodiment, the system utilizes a finite, plurality of longcodes for association with users, e.g., between 500 and 1,000 longcodes. The finite number of longcodes may be dynamic For example, the finite number of longcodes may be exchanged, replaced, or modified at predetermined time periods, upon occurrence of predetermined events, and/or selectively based upon admin-user inputs. In one embodiment, alias longcodes may be associated with geographical regions. In this way, a user initiating the provisioning sequence may be assigned, or have assigned to a recipient, a longcode associated with a geographical location corresponding to the user, e.g., by an area code in the example where the longcode is a phone number. In various embodiments, an originating user provisions a guest recipient with an alias.

In one embodiment utilizing SMS provisioning, the user 1 initiates a message communication to user 2 by sending the message to a predefined provisioning longcode or provisioning address, wherein the message includes the real address of user 2, e.g., a phone number. The messaging address is from the user's mobile device 10 to the gateway center 12 and then to the application server 50.

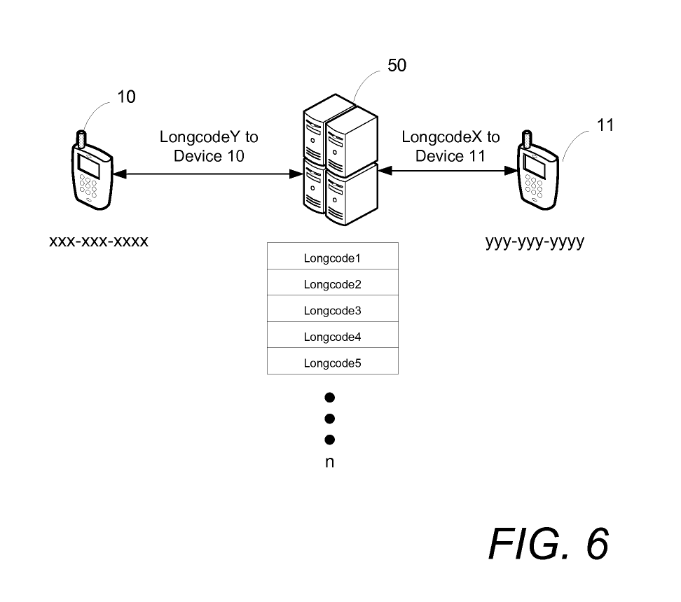

FIG. 6 shows an exemplary flow of communications among the mobile device 10 and 11 and the application server 50. In operation, from the perspective of user 1, communications from the mobile device 10 appear to originate from LongcodeY. From the perspective of user 2, communications from the mobile device 11 appear to originate from LongcodeX.

In various embodiments, the above processes and techniques may be configured within a mobile device using a downloaded browser-based application. Features of the application may be accessed by a native renderer for translating information in the browser-based application into native elements for output as rendered native elements for display on the native user interface, e.g., conversation, messaging, or SMS module.

In one embodiment, the native renderer is a program that executes on the processing unit(s). Thus, exemplary embodiments of the invention provide an exemplary benefit that the browser-based application needs only be written or updated once, and all computing devices will have an up-to-date version once the computing devices access and download the browser-based application. Furthermore, the native renderer renders native output, which means the browser-based application run via the native renderer will be faster, more user intuitive, and seamless than a browser-based application if the browser-based application is run in a browser.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. A method of obscuring a message origin for anonymity, the method comprising:
storing a finite plurality of alias addresses in a database;
in response to a request from an originating device, provisioning a first alias address of the finite plurality of alias addresses for a recipient device having a first real address, wherein the request is executed by supplying a predetermined ASCII character sequence before the first real address;
transmitting a message to the originating device from the first alias address;
receiving a message from the originating device addressed to the first alias address;
identifying a real address associated with the first alias address within the database based upon a second address that is associated with the originating device and the first alias address;
associating a second alias address of the finite plurality of alias addresses with the originating device having the second real address within the database;
associating the received message from the originating device with the first real address and the second alias within the database; and
transmitting the received message to the recipient device associated with the first real address using the second alias as an originating address.

2. The method of claim 1, further comprising:
receiving a response message from the recipient, addressed to the second alias;
identifying the second real address as associated with the second alias;
associating the response message from the recipient device with the second alias and the second real address; and
transmitting the response message to the originating device associated with the second real address, wherein the transmitting includes the second alias.

3. The method of claim 2, wherein the message from the originating device is a short message service message; and
wherein the response message from the recipient device is a short message service message.

4. The method of claim 2, wherein the transmitting the received message to the recipient device associated with the first real address is executed without transmitting the first real address.

5. The method of claim 2, wherein the transmitting the received message to the recipient device associated with the first real address is executed as originating from the second alias.

6. The method of claim 2, wherein the first and second real addresses are phone numbers.

7. The method of claim 2, wherein the first and second aliases are longcodes.

8. The method of claim 1, wherein at least one of the finite plurality of alias addresses are associated with a geographical region.

9. The method of claim 1, further comprising:
dynamically modifying the finite plurality of alias addresses.

10. A system comprising: at least one processing unit; a memory, operatively connected to the at least one processing unit and storing instructions that, when executed by the at least one processing unit, cause the at least one processing unit to perform a method, the method comprising:
storing a finite plurality of alias addresses in a database;
in response to a request from an originating device, provisioning a first alias of the finite plurality of alias addresses for a recipient device having a first real address, wherein the request is executed by supplying a predetermined ASCII character sequence before the first real address;
transmitting the first alias to the originating device;
receiving a message from the originating device addressed to the first alias;
identifying a real address associated with the first alias within the database;
associating a second alias of the finite plurality of alias addresses for an originating device having a second real address within the database;
associating the received message from the originating device with the first real address and the second alias within the database; and
transmitting the received message to the recipient device associated with the first real address, wherein the transmitting includes providing the second alias as an originating address.

11. The system of claim 10, wherein the method further comprises:
receiving a response message from the recipient device addressed to the second alias;
identifying the second real address within the database by the second real address's association with the second alias;
associating the response message from the recipient device with the first alias within the database; and
transmitting the response message to the originating device associated with the second real address, wherein the transmitting includes the first alias.

12. The system of claim 11, wherein the message from the originating device is a short message service message; and
wherein the response message from the recipient device is a short message service message.

13. The system of claim 11, wherein the transmitting the received message to the recipient device associated with the first real address is executed without transmitting the second real address.

14. The system of claim 11, wherein the transmitting the received message to the recipient device associated with the first real address is executed as originating from the second alias.

15. The system of claim 11, wherein the first and second real addresses are phone numbers.

16. The system of claim 11, wherein the first and second aliases are longcodes.

17. The system of claim 11, wherein at least one of the finite plurality of alias addresses are associated with a geographical region.

18. A non-transitory computer-readable storage medium comprising computer-executable instructions for performing a method comprising:
storing a finite plurality of alias addresses in a database;
in response to a request from an originating device, provisioning a first alias of the finite plurality of alias addresses for a recipient device having a first real address, wherein the request is executed by supplying a predetermined ASCII character sequence before the first real address;
transmitting the first alias to the originating device;
receiving a message and an encryption request from the originating device addressed to the first alias;
encrypting the message;
identifying a real address associated with the first alias within the database;
associating a second alias of the finite plurality of alias addresses for an originating device having a second real address within the database;
associating the received message from the originating device with the first real address and the second alias within the database; and
transmitting instructions for obtaining the received message to the recipient device associated with the first real address, wherein the transmitting includes providing the second alias as an originating address; and
transmitting the message to the recipient upon receipt of a correct predefined key.

19. The method of claim 18, further comprising:
receiving a response message from the recipient, addressed to the second alias;
identifying the second real address as associated with the second alias;
associating the response message from the recipient device with the second alias and the second real address; and
transmitting the response message to the originating device associated with the second real address, wherein the transmitting includes the second alias.

20. The system of claim 19, wherein the transmitting the received message to the recipient device associated with the first real address is executed without transmitting the second real address.
